(19) United States
(12) Patent Application Publication
(10) Pub. No.: US 2014/0015814 A1
(43) Pub. Date: Jan. 16, 2014

(54) DEVICE AND METHOD FOR ADJUSTING VIEWING ANGLE OF APPLIANCE DISPLAY

(71) Applicants: Omar Santana, Louisville, KY (US); Roman Roman Vila, Louisville, KY (US)

(72) Inventors: Omar Santana, Louisville, KY (US); Roman Roman Vila, Louisville, KY (US)

(73) Assignee: GENERAL ELECTRIC COMPANY, Schenectady, NY (US)

(21) Appl. No.: 13/546,325

(22) Filed: Jul. 11, 2012

(51) Int. Cl. G06F 3/038

(52) U.S. Cl. 345/204

(57) ABSTRACT

An appliance having a display and a system and method of adjusting a viewing angle of the display based on the position of a door of the appliance is provided. As a door of the appliance is pivotally rotated about an axis, a controller can control a motor to actuate a mounting plate of the display such that the mounting plate is rotated to adjust the viewing angle of the display. The rotation of mounting plate can be determined based on the position of the door of the appliance. A sensor can be implemented to detect the position of the door. The sensor can be disposed on a hinge of the door, in a cabinet of the appliance, or on a door of the appliance.

### FIELD OF THE INVENTION

The present disclosure relates to a display of an appliance and more particularly to an improved system and method of adjusting the viewing angle of the display of the appliance.

### BACKGROUND OF THE INVENTION

Appliances can include a display for providing visual information to a user. In addition, the display can be configured to be an input device to receive user initiated input. The display can be a flat panel display such as a liquid crystal display.

One type of liquid crystal display (LCD) used in appliances can be a super-twisted nematic (STN) display. A STN LCD relies on less power than other flat panel displays and is less expensive to manufacture. However, a STN LCD has a narrow viewing angle range making it difficult for a user to view the displayed information in certain positions. When a user is in a position outside of the viewing angle, the information displayed can have decreased contrast and appear blurry. At certain angles outside an acceptable viewing angle range, only a black LCD background can be seen, preventing the user from adequately viewing the information.

Conventionally, appliance displays were mounted on a door of an appliance. However, the mounting assembly was stationary and prevented the user from viewing the display when the door of the appliance was opened. In another conventional approach, a user could manually adjust the viewing angle of the display mounted on the appliance. The resulting position of the display is also stationary and when the door of the appliance is opened, the display is no longer visible to the user.

Thus, a need exists for an improved method for adjusting the viewing angle of a display of an appliance. A system and method that can adjust the viewing angle of the display based on the position of the appliance door would be particularly useful.

### BRIEF DESCRIPTION OF THE INVENTION

Aspects and advantages of the invention will be set forth in part in the following description, or may be apparent from the description, or may be learned through practice of the invention.

One exemplary aspect of the present disclosure is directed to an appliance. The appliance has a door configured to provide access to the appliance, a sensor configured to detect a position of the door, a display configured to provide visual information to a user, and a display mounting plate coupled to the door. The display mounting plate is configured to support the display. The appliance can further include a motor coupled to the display mounting plate. The motor is configured to actuate the display mounting plate to adjust a viewing angle of the display. The appliance can further include a controller coupled with the motor. The controller can be configured to receive a signal indicative of the position of the door and actuate the motor to adjust the viewing angle of the display based on the position of the door.

Another exemplary aspect of the present disclosure is directed to a method of adjusting a viewing angle of a display of an appliance. The method can include detecting a position of a door of the appliance with a sensor; determining, with a controller, a viewing angle of a display of the appliance based on the position of the door of the appliance; and controlling, with the controller, the viewing angle of the display based on the position of the door of the appliance.

Yet another exemplary aspect of the present disclosure is directed to a dishwasher. The dishwasher has a cabinet, a door configured to provide access to the dishwasher, a sensor configured to detect a position of the door, a display configured to provide visual information to a user, and a display mounting plate coupled to the door. The display mounting plate is configured to support the display. The dishwasher can further include a motor coupled to the display mounting plate. The motor is configured to actuate the display mounting plate to adjust a viewing angle of the display. The dishwasher further includes a controller coupled with the motor. The controller can be configured to receive a signal indicative of the position of the door and actuate the motor to adjust the viewing angle of the display based on the position of the door.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary dishwasher according to an exemplary embodiment of the present disclosure;

FIG. 2 depicts a cross-sectional view of an exemplary dishwasher according to an exemplary embodiment of the present disclosure;

FIG. 3 depicts an exemplary mounting plate according to an exemplary embodiment of the present disclosure;

FIGS. 4 and 5 depict an exemplary display assembly according to an exemplary embodiment of the present disclosure;

FIG. 6 depicts a block diagram of an exemplary display viewing angle control system according to an exemplary embodiment of the present disclosure;

FIG. 7 depicts a cross-sectional view of an exemplary dishwasher according to an exemplary embodiment of the present disclosure;

FIG. 8 depicts a cross-sectional view of an exemplary dishwasher according to an exemplary embodiment of the present disclosure;

FIG. 9 depicts an exemplary sensor assembly according to an exemplary embodiment of the present disclosure; and

FIG. 10 depicts a flow chart of an exemplary method of controlling a display viewing angle according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure relates to an appliance having a display and to a system and method of adjusting a viewing angle of the display based on the position of a door of the appliance. As a door of the appliance is pivotally rotated about an axis, a mounting plate of the display can be rotated to adjust the viewing angle of the display. For instance, a controller can control a motor to actuate the mounting plate about the axis. The rotation of mounting plate can be determined based on the position of the door of the appliance. A sensor can be implemented to detect the position of the door. The sensor can be disposed within a cabinet of the appliance.

According to aspects of the present disclosure, adjusting a viewing angle of an appliance display based on a position of a door of the appliance increases user visual access to the display. A user can adequately view information or input information to the display throughout the full range of motion of the door.

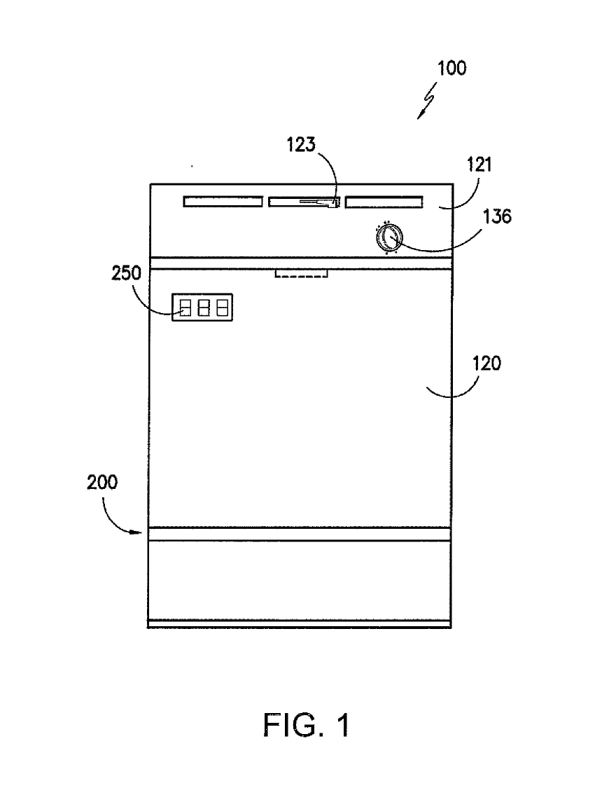

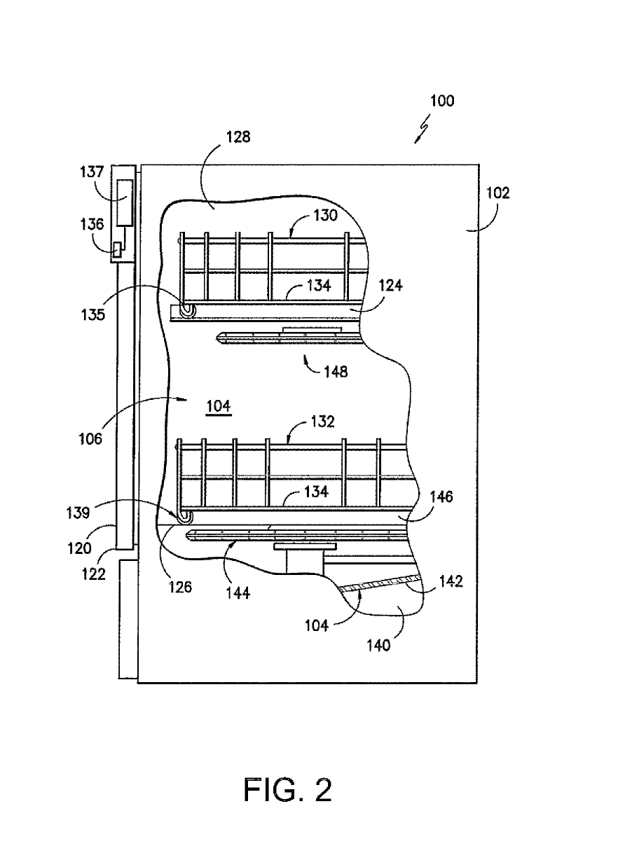

FIGS. 1 and 2 depict an exemplary dishwasher 100 according to an exemplary embodiment of the present disclosure where FIG. 1 is a front view of the exemplary dishwasher 100 and FIG. 2 is a cross-sectional view of the exemplary dishwasher. While the present disclosure will be discussed with reference to a dishwasher, the system and methods according to embodiments of the present disclosure are not limited to use with dishwashers and can be used with any other appliance having a display and a door, such as a refrigerator, a washing machine, a microwave, a dryer, etc.

As illustrated in FIGS. 1 and 2, dishwasher 100 can include a cabinet 102 having a tub 104 therein that defines a wash chamber 106. The tub 104 can include a door 120 hinged at its bottom 122 for pivotally rotatable movement between a normally closed configuration (shown in FIGS. 1 and 2), wherein the wash chamber 106 is sealed shut (e.g., for washing operation), and an open configuration (e.g., for loading and unloading of articles from the dishwasher). A latch 123 can be used to lock and unlock the door 120 for access to the chamber 106.

Upper and lower guide rails 124, 126 are mounted on tub side walls 128 and accommodate upper and lower roller-equipped rack assemblies 130, 132. Each of the upper and lower racks 130, 132 is fabricated into lattice structures including a plurality of elongated members 134. Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106. This is facilitated by rollers 135 and 139, for example, mounted onto racks 130 and 132, respectively. A silverware basket (not shown) may be removably attached to the lower rack 132 for placement of silverware, utensils, and the like, that are too small to be accommodated by the upper and lower racks 130, 132.

The dishwasher 100 can further include a lower spray-arm assembly 144 that is rotatably mounted within a lower region 146 of the wash chamber 106 and above a tub sump portion 142 so as to rotate in relatively close proximity to the lower rack 132. A mid-level spray-arm assembly 148 is located in an upper region of the wash chamber 106 and may be located in close proximity to upper rack 130. Additionally, an upper spray arm assembly (not shown) may be located above the upper rack 130.

The lower and mid-level spray-arm assemblies 144, 148 and the upper spray arm assembly (not shown) are fed by a fluid circulation assembly for circulating water and dishwasher fluid in the tub 104. The fluid circulation assembly can be located in a machinery compartment 140 located below the bottom sump portion 142 of the tub 104, as generally recognized in the art. Each spray-arm assembly includes an arrangement of discharge ports or orifices for directing washing liquid onto dishes or other articles located in the upper and lower racks 130, 132, respectively. The arrangement of the discharge ports in at least the lower spray-arm assembly 144 provides a rotational force by virtue of washing fluid flowing through the discharge ports. The resultant rotation of the lower spray-arm assembly 144 provides coverage of dishes and other dishwasher contents with a washing spray.

The dishwasher 100 can be further equipped with a controller 137 to regulate operation of the dishwasher 100. The controller 137 can be positioned in a variety of locations throughout dishwasher 100. In the illustrated embodiment, the controller 137 can be located within a control panel area 121 of door 120 as shown. In such an embodiment, input/output (“I/O”) signals may be routed between the control system and various operational components of dishwasher 100 along wiring harnesses that may be routed through the bottom 122 of door 120.

A display 250 can provide visual information and can be coupled to controller 137. Any type of characters can be displayed on the display 250 such as alphanumeric symbols, graphics, icons, etc. For instance, various operational options can be displayed such as water temperature, cycle strength, etc. In addition, display 250 can also be an input device such as a touch screen device that can allow a user to select a displayed option. Alternatively, dishwasher 100 can include an input device 136 separate from the display. The input device can include one or more of a variety of electrical, mechanical or electro-mechanical input devices including rotary dials (knobs), push buttons, toggle/rocker switches, and touch pads.

The display 250 can be positioned anywhere convenient to provide a user visual access to the display. For instance, the display 250 can be disposed on an outer surface of the door 120. Alternatively, the display 250 can be disposed on an upper surface of the door 120 not visible when the door 120 is in the closed position. Display 250 can also be positioned such that the outer surface of the display is flush with the outer surface of the door 120. Alternatively, the display 250 can protrude from a surface of the door 120. In addition, while the display 250 is shown to one side of the door 120, display 250 can also be located in the center of the door 120.

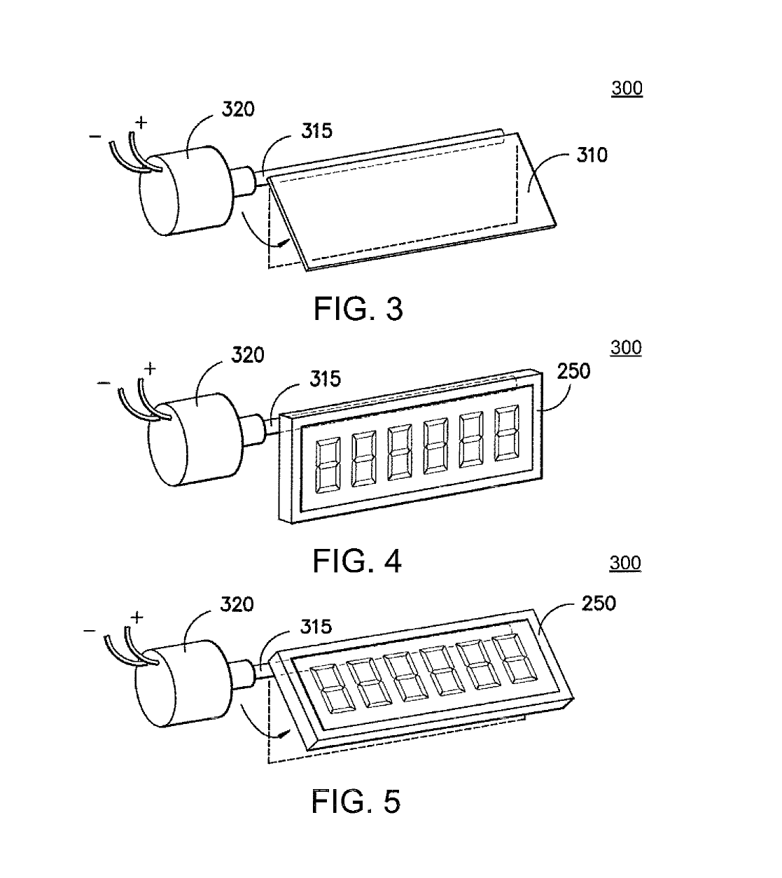

FIG. 3 depicts an exemplary mounting plate 310 of a display control assembly 300 according to an exemplary embodiment of the present disclosure. The mounting plate 310 can be coupled with a rotational arm 315 where the rotational arm 315 is coupled to a motor 320 such that the motor 320 actuates the mounting plate 310 to pivotally rotate about an axis. The mounting plate 310 and the motor 320 can be disposed within a door of the appliance. While the rotational arm 315 is illustrated as being coupled at a top surface of the mounting plate 310, the rotational arm 315 can be disposed at any position of the mounting plate 310.

FIGS. 4 and 5 depict an exemplary display control assembly 300 according to an exemplary embodiment of the present disclosure. The display control assembly 300 includes the display 250 coupled to the mounting plate 310. When the motor 320 actuates the rotational arm 315, the mounting plate 310 and the display 250 pivotally rotate about an axis. The mounting plate 310 and the display 250 are rotated based on a position of the door to achieve a corresponding viewing angle of the display 250 to improve the user's visual access to the display 250.

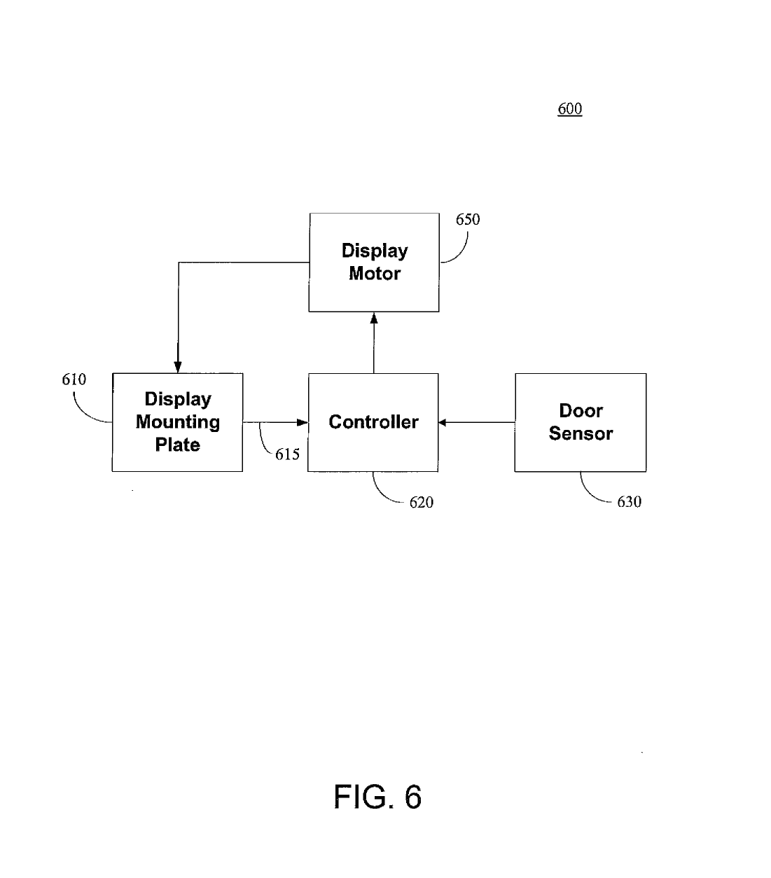

FIG. 6 depicts a block diagram of an exemplary display viewing angle control system 600 according to an exemplary embodiment of the present disclosure. The display viewing angle control system 600 can include a display mounting plate 610, a controller 620, a door sensor 630, and a display motor 650.

A display of an appliance can be coupled to a display mounting plate 610. The display mounting plate 610 can have any configuration and arrangement. For instance, the display mounting plate 610 can have a planar shape such that the display mounting plate 610 is substantially similar to the size and shape of the display. The display mounting plate 610 can be actuated to pivotally rotate about an axis by a display motor 650. A feedback line 615 from the display mounting plate 610 can be coupled with the controller 620 such that a current position of the display mounting plate 610 can be communicated to the controller 620.

Display motor 650 can be any type of motor. For instance, the display motor can be a DC stepper motor such that the display motor 650 actuates the mounting plate 610 in predetermined step intervals. The display motor 650 can actuate the mounting plate 610 to rotate in a direction opposite to the direction the appliance door is opening.

Door sensor 630 can be any type of sensor that can be used to determine the position of the appliance door. For instance, door sensor 630 can be an infrared sensing device. Alternatively, the door sensor 630 can be a magnetoresistive angle sensing device that includes a resistive sensing circuit disposed in the cabinet of the appliance and a magnetic device coupled to the door, such as the hinge of the door.

The controller 620 can determine a viewing angle of the display based on the position of the appliance door (not shown) and control the display viewing angle control system 600 to achieve the desired viewing angle. Controller 620 can be positioned in any location within the appliance. For instance, controller 620 can be located within the control panel area. Various input/output (I/O) signals can be routed between the controller and various operational components of the appliance, such as user inputs, a display, sensor(s), alarms, and/or other components. In addition, controller 620 can be the only controller of the appliance or it could alternatively be a subcontroller responsible for at least the viewing angle display control and coupled with the overall appliance controller.

By way of example, any/all of the “controllers” discussed in this disclosure can include a memory and one or more processing devices such as microprocessors, CPUs or the like, such as general or special purpose microprocessors operable to execute programming instructions or micro-control code associated with operation of an appliance such as a dishwasher. The memory can represent random access memory such as DRAM, or read only memory such as ROM or FLASH. In one embodiment, the processor executes programming instructions stored in memory. The memory can be a separate component from the processor or can be included onboard within the processor. Alternatively, the controller might also be constructed without using a microprocessor, using a combination of discrete analog and/or digital logic circuitry (such as switches, amplifiers, integrators, comparators, flip-flops, AND gates, and the like) to perform control functionality instead of relying upon software.

More particularly, a position of the appliance door (not shown) can be detected using a door sensor 630 coupled to the appliance door. The signal indicative of the door position can be sent to controller 620. Door position can include the angle at which the door is located relative to a closed position. Controller 620 can determine a viewing angle corresponding to the detected door position where the door position can be a single value or a range of values. For instance, the detected door position can correlate to a predetermined viewing angle using a lookup table, an algorithm, an equation, and/or a model.

After determining the viewing angle, the controller 620 can compare the current mounting plate position with the desired mounting plate position corresponding to the determined viewing angle. The controller 620 can then actuate the display motor 650 to the determined viewing angle.

In an embodiment of the present disclosure, when the door is in the closed position, the display can be in a position such that the mounting plate 610 is parallel to the appliance door surface. This position can be considered a reference viewing angle position. However, a setup mode can be executed such that the viewing angle of the display is different from the reference viewing angle position. For instance, a user can input information such as desired viewing angle when the appliance door is closed. Alternatively, a user can input parameters such as user height and the controller can calculate and control the display control assembly to achieve viewing angles based on the input parameters.

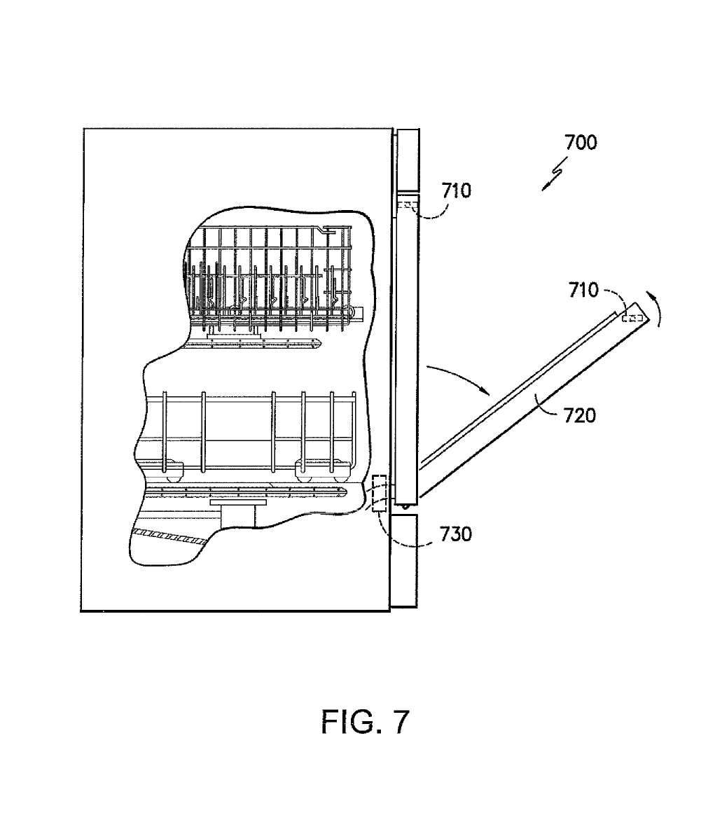

FIG. 7 depicts a cross-sectional view of an exemplary dishwasher 700 according to an exemplary embodiment of the present disclosure. In this embodiment, the display 710 can be disposed in an upper surface of the door 720 such that it is hidden from a user's sight when the door is in a closed position. In addition, the display 710 can be encapsulated with a transparent material. The transparent material can have rounded edges to provide visual access to the display throughout the entire range of rotation.

As the door 720 is pivotally rotated in a first direction, the display 710 is pivotally rotated in a second direction opposite the first direction. For instance, as the door 720 is opened, a sensor 730 detects the position of door 720 and the display 710 is rotated away from the door to a viewing angle corresponding with the position of the door. Likewise, when the sensor 730 detects that the position of the door is closing, the display 710 is rotated in an opposite direction, eventually returning to an original position. The display 710 can rotate within the door 720 such that the display does not protrude from the door. Alternatively, the display 710 can protrude from the door during rotation.

The sensor 730 can be disposed anywhere in the appliance such that the position of the door can be detected. For instance, the sensor can be disposed on a hinge of the door, in a cabinet of the appliance, or on a door of the appliance.

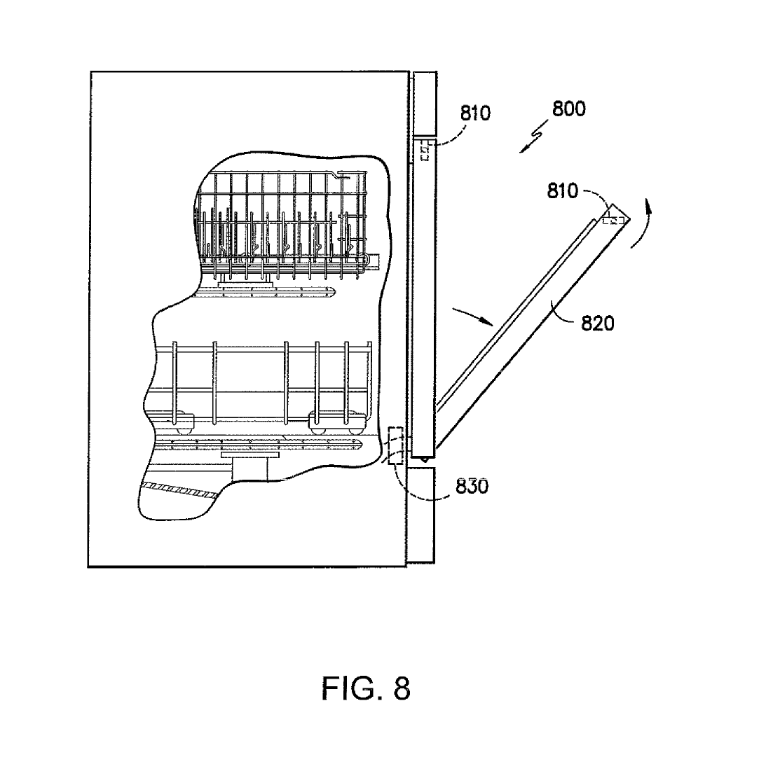

FIG. 8 depicts a cross-sectional view of an exemplary dishwasher 800 according to an exemplary embodiment of the present disclosure. In this embodiment, display 810 can be disposed such that a user is provided visual access from a front surface of the door 820. The display 810 can be encapsulated with a transparent material. The transparent material can have rounded edges to provide visual access to the display throughout the entire range of rotation.

As the door 820 is pivotally rotated in a first direction, the display 810 is pivotally rotated in a second direction opposite the first direction. For instance, as the door 820 is opened, a sensor 830 detects the position of door 820 and the display 810 is rotated to a viewing angle corresponding with the position of the door. For instance, the display can rotate from a vertical position, to a horizontal position and beyond such that the angle of rotation exceeds 90°. Likewise, when the sensor 830 detects that the position of the door is closing, the display 810 is rotated in an opposite direction, eventually returning to an original position. Display 810 can be positioned so as not to protrude from the outer surface of the door 820. Alternatively, display 810 can protrude from the outer surface of the door 820.

The sensor 830 can be disposed anywhere in the appliance such that the position of the door can be detected. For instance, the sensor can be disposed on a hinge of the door, in a cabinet of the appliance, or on a door of the appliance.

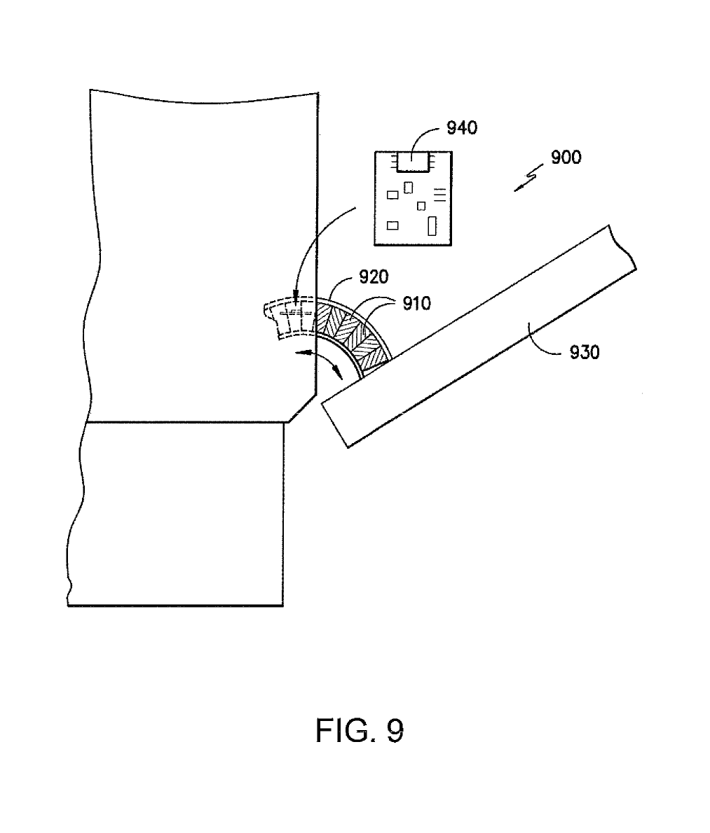

FIG. 9 depicts an exemplary sensor assembly 900 according to an exemplary embodiment of the present disclosure. The sensor assembly 900 can include a magnetic strip having a plurality of poles 910 coupled to a hinge 920 of an appliance. The poles 910 can include alternating polarity such as north pole regions and south pole regions. As a door 930 is rotated a sensor 940 detects the position of the door using the magnetic strips 910. For instance, each change in polarity can correspond to a known displacement angle of the door 930. The magnetic strips 910 can be separately attached to the hinge 920 or the magnetic strips 910 can be integrally formed with the hinge 920.

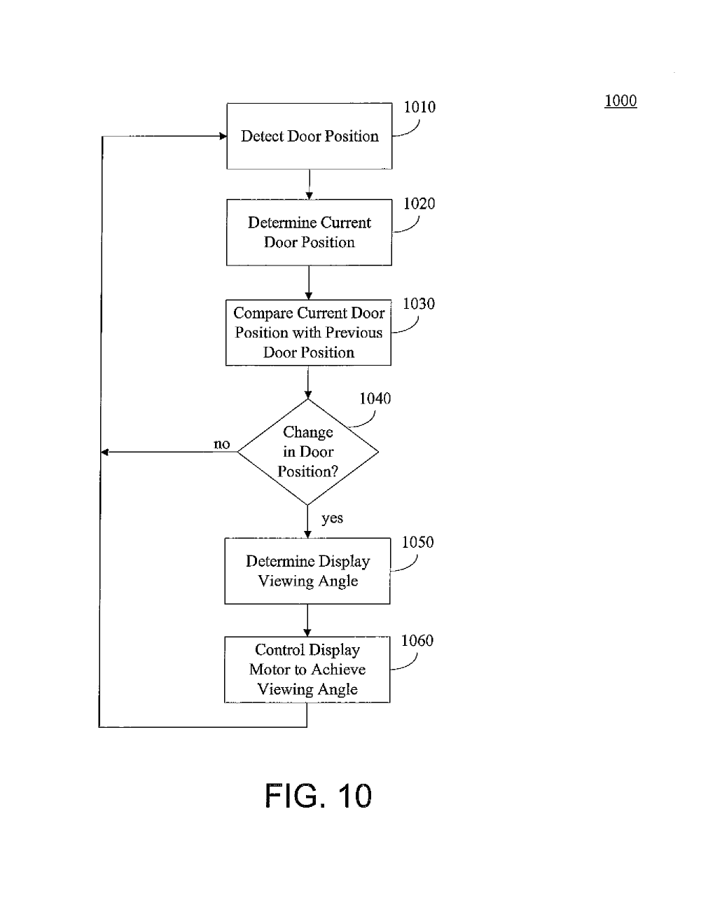

FIG. 10 illustrates a flow chart of an exemplary method according to an exemplary embodiment of the present disclosure. The method can be implemented with any suitable appliance having a door and a display. In addition, although FIG. 10 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

FIG. 10 provides a flow chart of an exemplary method 1000 of controlling a viewing angle of a display in an appliance. At (1010), a sensor can detect a door position and send a signal indicative of the door position to a controller. The controller can determine the current door position at (1020) and compare the current door position with the previous door position at (1030). At (1040) the controller can determine if there is a change in door position and if there is a change in position, determine the display viewing angle corresponding to the change in position at (1050). The controller can control a display motor to achieve the determined viewing angle at (1060). A door position can be continuously detected by returning to (1010) even after a change in the door position is detected.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance comprising:
a door configured to provide access to the appliance;
a sensor configured to detect a position of the door;
a display configured to provide visual information to a user;
a display mounting plate coupled to the door, the display mounting plate configured to support the display;
a motor coupled to the display mounting plate, the motor configured to actuate the display mounting plate to adjust a viewing angle of the display; and
a controller coupled with the motor, the controller configured to receive a signal indicative of the position of the door and control the motor to adjust the viewing angle of the display based on the position of the door.

2. The appliance as in claim 1, further comprising a hinge coupled to the door, wherein the sensor detects the position of the door based on a position of the hinge.

3. The appliance as in claim 2, wherein the sensor is disposed inside a cabinet of the appliance.

4. The appliance as in claim 1, wherein the sensor is an infrared sensor or a magnetoresitive sensor.

5. The appliance as in claim 1, wherein the motor is a stepper motor configured to actuate the display mounting plate in a clockwise and counter-clockwise direction.

6. A method of adjusting a viewing angle of a display of an appliance comprising:
detecting a position of a door of the appliance with a sensor;
determining, with a controller, a viewing angle of a display of the appliance based on the position of the door of the appliance; and
controlling, with the controller, the viewing angle of the display based on the position of the door of the appliance.

7. The method as in claim 6, wherein determining a viewing angle of a display of the appliance based on the position of the door of the appliance comprises comparing a current position of the door of the appliance with a previous position of the door of the appliance and determining the viewing angle of the display of the appliance based on the difference between the current position of the door of the appliance and the previous position of the door of the appliance.

8. The method as in claim 6, wherein controlling the viewing angle of the display based on the position of the door of the appliance comprises controlling a motor to actuate a display mounting plate to achieve the viewing angle of the display based on the position of the door of the appliance.

9. The method as in claim 8, further comprising determining a number of steps needed to achieve a viewing angle, wherein the motor is a stepper motor configured to actuate the display mounting plate in a clockwise and counter-clockwise direction.

10. The method as in claim 8 , wherein the motor actuates the display mounting plate in a first direction when the door is opening and actuates the display mounting plate in a second direction, opposite the first direction when the door is closing.

11. The method as in claim 6, wherein the position of the door of the appliance is detected based on a position of a hinge coupled to the door of the appliance.

12. A dishwasher comprising:
a cabinet;
a door configured to provide access to the dishwasher;
a sensor configured to detect a position of the door;
a display configured to provide visual information to a user;
a display mounting plate coupled to the door, the display mounting plate configured to support the display;
a motor coupled to the display mounting plate, the motor configured to actuate the display mounting plate to adjust a viewing angle of the display; and
a controller coupled with the motor, wherein the controller is configured to receive a signal indicative of the position of the door and control the motor to adjust the viewing angle of the display based on the position of the door.

13. The dishwasher as in claim 12, further comprising a hinge coupled to the door, wherein the sensor detects the position of the door based on a position of the hinge.

14. The dishwasher as in claim 12, wherein the sensor is an infrared sensor or a magnetoresitive sensor.

15. The dishwasher as in claim 12, wherein the motor is a stepper motor configured to actuate the display mounting plate in a clockwise and counter-clockwise direction.

16. The dishwasher as in claim 12, wherein the display is mounted on a front surface of the door of the dishwasher or a top surface of the door of the dishwasher.
